(19) United States
(12) Patent Application Publication
(10) Pub. No.: US 2005/0028645 A1
(43) Pub. Date: Feb. 10, 2005

(54) Bottle cap remover

(76) Inventors: Adriana Velez, Lake Worth, FL (US); Scott Cooper, Lake Worth, FL (US); Steven M. Greenberg, Wellington, FL (US); Michael Edwin Langley, Taft, TN (US)

Correspondence Address: Steven M. Greenberg, Esq.;GVC Marketing, LLC, Suite 3, 6770 Lantana Road, Lake Worth, FL, 33467, US

(21) Appl. No.: 10/912,875

(22) Filed: Aug. 6, 2004

Related U.S. Application Data
(60) Provisional application No. 60/493,286, filed on Aug. 7, 2003.

(51) Int. Cl. B67B 7/14

(52) U.S. Cl. 81/3.4

(57) ABSTRACT

A bottle cap remover can include structure for facilitating the assembly of the bottle cap remover. The structure can include a slot established within the top portion of an interior surface of the body of the bottle cap remover. The cover of the bottle cap remover, by comparison, can include an indexing guide formed within the interior surface of the cover which can cooperatively mate with a companion guide in the body of the bottle cap remover to ensure the proper alignment of the cover with the body. Moreover, a circular trench about the interior perimeter of the cover can facilitate the mating and securing of the cover to the body of the bottle cap remover.

### CROSS-REFERENCE TO RELATED APPLICATIONS

This patent application claims the benefit under 35 U.S.C. § 119(e) as a continuation of presently pending U.S. Provisional Patent Application 60/493,286, entitled BOTTLE CAP REMOVER, filed on Aug. 7, 2003, the entire teachings of which are incorporated herein by reference.

### BACKGROUND OF THE INVENTION

1. Statement of the Technical Field

The present invention relates to the field of bottle cap removers.

2. Description of the Related Art

Bottles have long been the preferred container for liquid beverages. During the latter portion of the twentieth century when cheaply manufactured aluminum containers became all the rage, bottles remained a viable alternative container, notwithstanding the increased cost of glass bottles. Importantly, consumers prefer glass bottles to aluminum cans because oftentimes, the flavor of a beverage can become altered through contact with the inner walls of the aluminum can. By comparison, the inner walls of the glass bottle can have a negligible impact upon the flavor of a beverage. Hence, the glass bottle remains the preferred choice for beverage storage.

It is well known that a multiplicity of techniques exist for securing the contents of a beverage in a bottle. The most popular choice includes the “crown cap”. Typically, a crown cap can be removed according to two methodologies. The first methodology, the twist-off methodology, requires that the end user simply grip the crown cap and with a rotational movement, the end user can remove the cap. By comparison, in the second methodology, the crown cap so tightly grips the bottle that a simple twist-off motion will not suffice. Rather, a bottle opener will be required to remove the crown cap to access the beverage.

Several bottle openers have been developed to facilitate the removal of the crown type bottle cap. Most skilled artisans will recognize the popularity of the lever type bottle opener. In the lever type bottle opener, a distal end of the lever can grip the crown cap at the intersection of the bottle neck and the cap. An upward motion of the lever can outwardly bend the edge of the cap enough to allow the interior of the bottle to pressurize with outside air. The pressurization of the bottle, in turn, can facilitate the removal of the cap by continuing the upward motion. Importantly, the operation of the lever type bottle opener can be physically demanding, especially for repeated uses. Moreover, it is not uncommon for the lever type opener to lose its grip upon the cap, thus causing slippage.

Several have proposed alternative cap removers in direct response to the known deficiencies of the lever type bottle cap remover. As an example, U.S. Pat. No. 4,414,866 to Kichijyo for CAP REMOVER discloses a spring-loaded cylindrical cap remover which can be coupled to a crown cap in such a manner as to avoid slippage. In particular, an orifice disposed at the bottom end of the Kichijyo cap remover can complete enclose the crown cap and the tip of the bottle. By pressing the cap remover downwards towards the bottom of the bottle, the edge of the crown cap can become engaged to a gripping member of the cap remover. A subsequent opposite upwards motion away from the bottom of the bottle can cause the crown cap to be removed in the same manner as the lever type cap remover. Yet, no slippage can occur because the orifice can surround the cap and the tip of the bottle, preventing the lateral movement thereof.

Despite the apparent advantages of the Kichijyo cap remover in operation, manufacturing the Kichijyo cap remover has proven problematic. In particular, the top cover of the cap remover must be aligned at the time of assembly so that the upper arm of the internal cap removing mechanism can communicate with a fixed protruding actuator extending from the interior surface of the cover portion. This communication permits the proper engagement and securing of the cap removing mechanism with the bottle cap. If the cover of the cap remover becomes misaligned, the cap removing mechanism cannot properly engage and secure the cap.

### SUMMARY OF THE INVENTION

The present invention addresses the deficiencies of the art in respect to bottle cap removers and provides a novel and non-obvious system and apparatus for removing crown type bottle caps.

Methods consistent with the present invention provide a method for orienting and assembling a bottle cap remover so that the actuating post of the cover of the bottle cap remover can engage the lever of the bottle cap remover assembly to ensure the proper operation of the bottle cap remover.

Systems consistent with the present invention include indexing structure formed in the cover and body of the bottle cap remover to ensure the proper alignment of the cover with the body during assembly. An ellipsoidal slot defined within the perimeter of the cover further can ensure the security of the cover with the body of the bottle cap remover.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute part of the this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial view of a bottle cap remover which has been configured according to a preferred aspect of the inventive arrangements;

FIG. 2A is a front view of a cover portion of the bottle cap remover of FIG. 1;

FIG. 2B is a side view of the cover of the bottle cap remover of FIG. 1;

FIG. 2C is a bottom view of the cover of the bottle cap remover of FIG. 1;

FIG. 3A is a pictorial view of a bottle cap remover configured with an attachment point for securing the bottle cap remover of FIG. 1;

FIG. 3B is a pictorial view of a bottle cap remover configured with a hitch for securing the bottle cap remover of FIG. 1; and,

FIG. 4 is a side view of a bottle cap remover configured with a translucent body through which the bottle cap removing mechanism of the bottle cap remover can be viewed.

### DETAILED DESCRIPTION OF THE PREFERRED EMBODIMENTS

The present invention is a bottle cap remover. In accordance with the inventive arrangements, the bottle cap remover of the present invention can include structure for facilitating the assembly of the bottle cap remover. The structure can include a slot established within the top portion of an interior surface of the body of the bottle cap remover. The cover of the bottle cap remover, by comparison, can include an indexing guide formed within the interior surface of the cover which can cooperatively mate with a companion guide in the body of the bottle cap remover to ensure the proper alignment of the cover with the body. Moreover, a circular trench about the interior perimeter of the cover can facilitate the mating and securing of the cover to the body of the bottle cap remover.

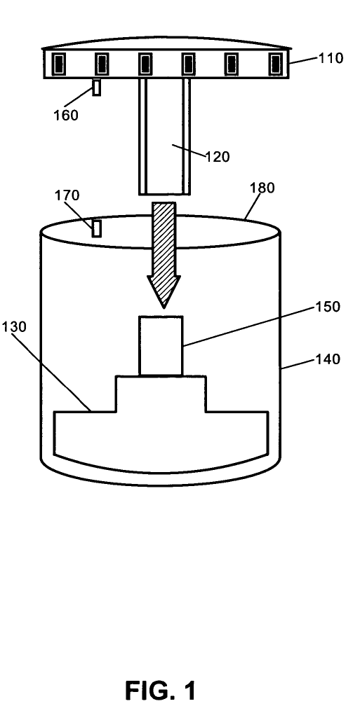

FIG. 1 is a pictorial view of a bottle cap remover which has been configured according to a preferred aspect of the inventive arrangements. The bottle cap remover can include a cover portion 110 configured for engagement with a bottle cap remover body 140. An actuating post 120 can extend from the interior surface of the cover portion 110 for engagement with a lever arm 150 of the an internal bottle cap removal assembly 130 disposed within the body 140. Importantly, to ensure the proper engagement of the actuating post 120 with the lever (without which the bottle opener can be rendered inoperable), an indexing guide 160 can be disposed within the interior portion of the cover 110. A complementary indexing guide 170 can be formed within the interior of the body 140 so that the indexing guide 160 can mate with the complementary indexing guide 170, thus, ensuring the proper alignment of the cover 110 with the body 140.

Importantly, one skilled in the art will recognize that the indexing structure 160, 170 need not be limited to any specific orientation or structure. Rather, any system for aligning the separation indexing guides 160, 170 is contemplated to fall within the scope of the present invention. To that end, for exemplary purposes only, it will be understood that the indexing guides 160, 170 can include complimentary protrusions and slots formed within the interior portion of the cover 110 and the exterior portion of the body 140, or complimentary protrusions and slots formed on the exterior portion of the cover 110 and the interior portion of the body 140, or complimentary protrusions and slots formed on the exterior portions of both the cover 110 and the body 140, or complimentary protrusions and slots formed on the interior portions of the cover 110 and the body 140.

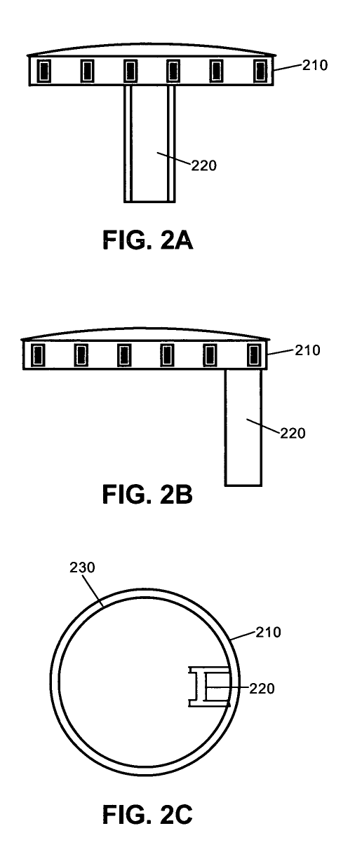

FIG. 2A is a front view of a cover portion of the bottle cap remover of FIG. 1. Similarly, FIG. 2B is a side view of a cover portion of the bottle cap remover of FIG. 1. As shown in both illustrations, the cover portion can include capping structure 210 and an actuating post 220. FIG. 2C is a bottom view of a cover portion of the bottle cap remover of FIG. 1. Importantly, as shown in FIG. 2C, the interior perimeter 210 of the capping structure 210 can define an ellipsoidal slot 230 configured to engage the top perimeter edge 180 of the body 140 of the bottle cap remover of FIG. 1. In this way, the cap installation can be more positive and, when combined with the indexing structure 160, 170, the possibility of misalignment and misorientation during assembly can be eliminated.

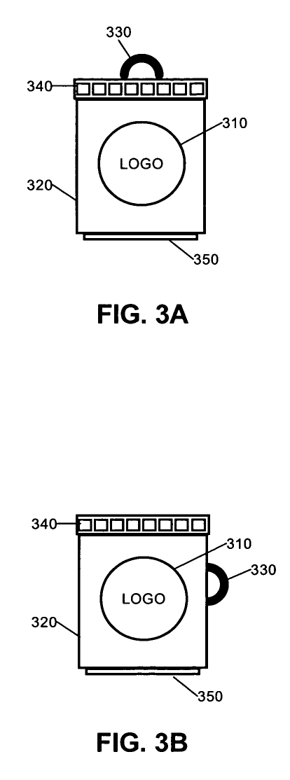

Notably, to facilitate in the use of the bottle cap remover of the present invention in high volume circumstances, such as the case of a commercial bar, the bottle cap remover can be configured for coupling to a bartender or other end user. In this regard, FIG. 3A is a pictorial view of a bottle cap remover configured with an attachment point for securing the bottle cap remover of FIG. 1. As before, the bottle cap remover can include a body 320 and a cover 340. A cap remover assembly 350 can be disposed within the body 340 which cap remover assembly 350 can remove crown type caps from bottles. Importantly, an attachment point 330 can be mounted to the cover 340 through which a lanyard, clip or other securing means, including a magnet, can be coupled to the bottle cap remover. Alternatively, the attachment point 330 can be mounted to the body 320 as shown in FIG. 3B. Finally, it will be recognized by those skilled in the promotional products industry that a marketing logo 310 can be printed on the body 320 or the cover 340 of the bottle cap remover.

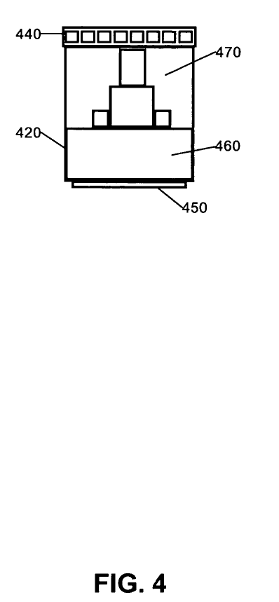

Significantly, to emulate the look and feel of a bottle, the body of the bottle cap remover can be formed as translucent in color. Specifically, as shown in FIG. 4, the bottle cap remover can include a cover 440 shaped like a crown cap, and a body 420. A bottle cap removal assembly 460 can be disposed within the body 420 with which bottle caps can be removed when inserted through the orifice 450. Importantly, the body 420 can have a translucent color 470 so that the bottle cap removal assembly 460 can be to the naked eye. In this way, consumers can view the operation of the bottle cap assembly 460. Notably, the body 420 can be in the shape of a bottle.

Significantly, this invention can be embodied in other specific forms without departing from the spirit or essential attributes thereof, and accordingly, reference should be had to the following claims, rather than to the foregoing specification, as indicating the scope of the invention.

1. A bottle cap remover comprising:
a cylindrical housing;
a cap removal assembly disposed at a first end of an interior portion of said housing; and,
a removable cover disposed at a second end opposite to said first end.

2. The bottle cap remover of claim 1, further comprising:
an indexing guide established within a top portion of an interior surface of said second end of said cylindrical housing; and,
a complimentary indexing guide formed within an interior surface of said removable cover;
wherein said indexing guide and said complimentary indexing guide are arranged for cooperative mating to ensure proper alignment between said removable cover and said cap removal assembly.

3. The bottle cap remover of claim 1, further comprising:
a protrusion established within an interior surface of said removable cover; and,
a slot formed within a top portion of an interior surface of said second end of said cylindrical housing;
wherein said protrusion and said slot are arranged for cooperative mating to ensure proper alignment between said removable cover and said cap removal assembly.

4. The bottle cap remover of claim 1, further comprising:
a protrusion established within a top portion of an interior surface of said second end of said cylindrical housing; and,
a slot formed within an interior surface of said removable cover;
wherein said protrusion and said slot are arranged for cooperative mating to ensure proper alignment between said removable cover and said cap removal assembly.

5. The bottle cap remover of claim 1, further comprising a ellipsoidal slot about an interior perimeter of said removable cover for facilitating mating and securing of said removable cover to said cylindrical housing.

6. The bottle cap remover of claim 1, further comprising an actuating post extending from an interior surface of said removable cover for engaging a lever arm of said cap removal assembly.

7. The bottle cap remover of claim 1, wherein said removable cover has a crown cap shape.

8. The bottle cap remover of claim 1, further comprising at least one attachment point affixed to an exterior portion of said cylindrical housing.

9. The bottle cap remover of claim 1, further comprising at least one attachment point affixed to an exterior portion of said removable cover.

10. The bottle cap remover of claim 8, wherein said attachment point is a magnet.

11. The bottle cap remover of claim 9, wherein said attachment point is a magnet.

12. The bottle cap remover of claim 1, wherein said cylindrical housing is translucent.

13. The bottle cap remover of claim 1, wherein said cylindrical housing has a logo disposed about an exterior portion of said cylindrical housing.

14. The bottle cap remover of claim 1, wherein said removable cover has a logo disposed about an exterior portion of said cylindrical housing.

15. A method for assembling a bottle cap remover comprising the steps of:
aligning an indexing guide in a removable cover with a counterpart indexing guide in a cylindrical housing;
securing said removable cover to a top portion of said cylindrical housing while maintaining said alignment; and,
inserting a cap removal assembly in a bottom portion of said cylindrical housing.

16. The method of claim 15, further wherein said aligning step further comprises the step of aligning an actuating post extending from an interior surface of said removable cover to engage a lever arm of said cap removal assembly.

17. The method of claim 15, further comprising the step of printing a logo on an exterior surface of said cylindrical housing.

18. The method of claim 15, further comprising the step of printing a logo on an exterior surface of said removable cover.

19. The method of claim 15, further comprising the step of securing an attachment point to an exterior portion of said cylindrical housing.

20. The method of claim 15, further comprising the step of forming said cylindrical housing in a translucent color.
